(19) United States
(12) Patent Application Publication
(10) Pub. No.: US 2026/0256647 A1
(43) Pub. Date: Sep. 3, 2026

(54) MASSAGE DEVICE

(71) Applicant: SKG Health Technologies Co., Ltd., Shenzhen (CN)

(72) Inventor: Zhenxing He, Shenzhen (CN)

(21) Appl. No.: 19/410,144

(22) Filed: Dec. 5, 2025

(30) Foreign Application Priority Data
Mar. 3, 2025 (CN) 202510245932.0

(51) Int. Cl. A61H 23/02

(52) U.S. Cl. CPC A61H 23/0263; A61H 2201/1215; A61H 2201/165

(57) ABSTRACT

A massage device includes a wearing mechanism and a massage mechanism, wherein the wearing mechanism is used for being worn on a part to be massaged, and the wearing mechanism includes a massage surface matched with target area; the massage mechanism is arranged on the wearing mechanism and corresponds to the massage surface, the massage mechanism includes a motor and an eccentric structure, the eccentric structure is arranged on a motor shaft of the motor, a gravity center of the eccentric structure is deviated from an axis of the motor shaft, and a first included angle is formed between the axis of the motor shaft and the massage surface.

### CROSS-REFERENCE TO RELATED APPLICATIONS

This application claims priority to Chinese Patent Application No.202510245932.0, filed on March 3,2025, the entire contents of which are hereby incorporated by reference in its entirety.

### FIELD

The disclosure relates to the technical field of massage devices, and particularly relates to a massage device.

### BACKGROUND

The massage device is a device capable of massaging a part to be massaged of a human body. Specifically, the massage device usually includes a massage mechanism and a wearing mechanism, the massage mechanism is arranged on the wearing mechanism, and the wearing mechanism is used for being worn on a target area of the human body. In this way, the massage of the target area of the human body can be realized by the movement of the massage mechanism on the premise that the wearing mechanism is worn on the human body. However, the massage effect of the massage mechanism in the related art on the target area of the human body is not ideal.

### SUMMARY

The disclosure provides a massage device which can massage in a flinging and rubbing mode and has a better massage effect.

In order to realize the above object, the disclosure provides a massage device which includes a wearing mechanism and a massage mechanism.

The wearing mechanism is configured to be worn on a target area and is formed with a massage surface matched with the target area.

The massage mechanism is arranged on the wearing mechanism and is matched with the massage surface in position. The massage mechanism includes a motor and an eccentric structure. The eccentric structure is arranged on a motor shaft of the motor. A gravity center of the eccentric structure is deviated from an axis of the motor shaft, and a first included angle is formed between the axis of the motor shaft and the massage surface.

### DESCRIPTION OF DRAWINGS

In order to more clearly illustrate the technical solutions in the embodiments of the present disclosure, the following briefly introduces the drawings required in the embodiments. Obviously, the drawings in the following description merely show some of the embodiments of the present disclosure, and other drawings can be obtained by those of ordinary skill in the art without creative efforts.

FIG. 1 is a structural schematic diagram of a massage device according to some embodiments of the present disclosure;

FIG. 2 is a structural schematic diagram of the massage device in FIG. 1 from another angle;

FIG. 3 is a structural schematic diagram of the massage device in FIG. 1 when worn on a part to be massaged;

FIG. 4 is a structural schematic diagram of the massage device in FIG. 3 after being detached from the target area;

FIG. 5 is an exploded view of the massage device in FIG. 1;

FIG. 6 is an exploded view of a massage mechanism in FIG. 5;

FIG. 7 is a structural schematic diagram of the massage mechanism in FIG. 6 after being disassembled;

FIG. 8 is a structural schematic diagram of the massage mechanism in FIG. 7 from another angle;

FIG. 9 is a sectional view of the massage mechanism in FIG. 8 at position A-A;

FIG. 10 is a structural schematic diagram of an installation part in FIG. 6.

### DETAILED DESCRIPTION

The technical solutions in the embodiments of the present disclosure will be clearly and completely described below in combination with the drawings in the embodiments of the present disclosure. Obviously, the described embodiments are only part of the embodiments of the present disclosure, rather than all the embodiments. Based on the embodiments in the present disclosure, all the other embodiments obtained by those skilled in the art without creative work are within the protection scope of the present disclosure.

In the present disclosure, the terms "upper", "lower", "left", "right", "front", "rear", "top", "bottom", "inner", "outer", "middle", "vertical", "horizontal", "transverse", "longitudinal", and the like indicate the orientation or positional relationship based on the orientation or positional relationship shown in the drawings. These terms are mainly used to better describe the present disclosure and its embodiments, and are not used to limit the indicated devices, elements or components to have a specific orientation, or to be constructed and operated in a specific orientation.

In addition, some of the above terms can be used to represent other meanings in addition to the orientation or positional relationship, for example, the term "upper" can also be used to represent a certain attachment relationship or connection relationship in some cases. Those of ordinary skill in the art can understand the specific meanings of these terms in the present disclosure according to specific circumstances.

In addition, the terms "mount", "set", "provided with", "connect", "connect" should be broadly construed. For example, it can be a fixed connection, a detachable connection, or a one-piece structure; it can be a mechanical connection or an electrical connection; it can be directly connected, or indirectly connected through an intermediate medium, or the internal communication between two devices, elements or components. Those of ordinary skill in the art can understand the specific meanings of the above terms in the present disclosure according to specific circumstances.

In addition, the terms "first", "second", and the like are mainly used to distinguish different devices, elements or components (the specific types and structures can be the same or different), and are not used to indicate or imply the relative importance and quantity of the indicated devices, elements or components. Unless otherwise specified, "a plurality of" means two or more.

Before the technical solutions of the present disclosure are explained, the background of the present disclosure is explained.

The massage device is a device capable of massaging a part of a human body to be massaged. Specifically, the massage device usually includes a massage mechanism and a wearing mechanism, the massage mechanism is arranged on the wearing mechanism, and the wearing mechanism is used for being worn on the part of the human body to be massaged. In this way, the massage of the part of the human body to be massaged can be realized by the movement of the massage mechanism on the premise that the wearing mechanism is worn on the human body. However, the massage effect of the massage mechanism in the related art on the part of the human body to be massaged is not ideal. Therefore, a massage device is provided to improve the massage effect to solve the above problem.

The technical solutions of the present disclosure are described below in combination with specific embodiments and drawings.

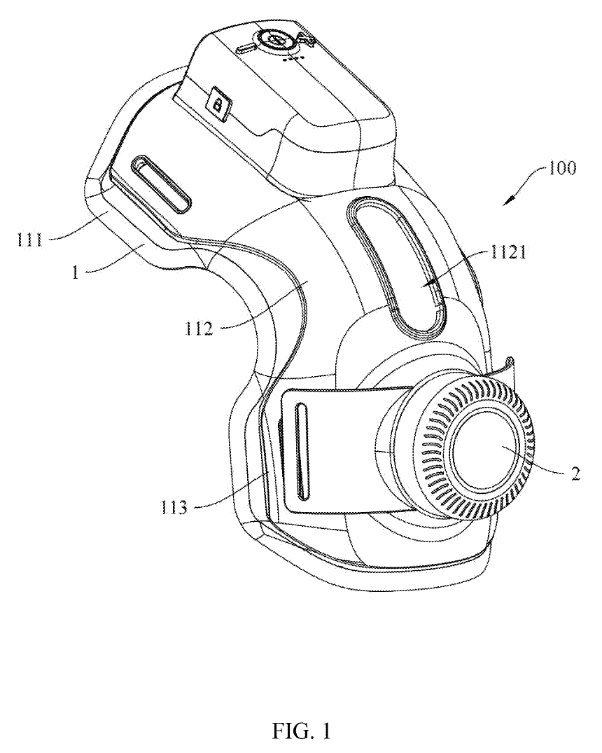

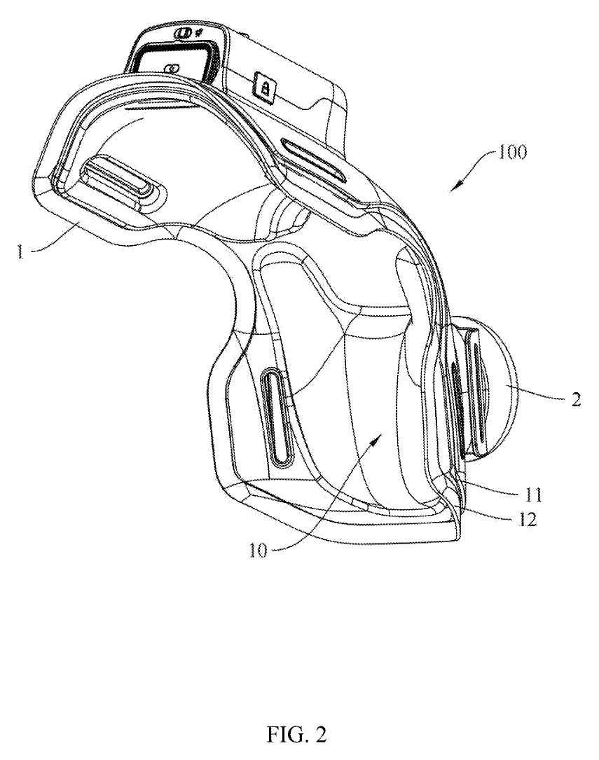

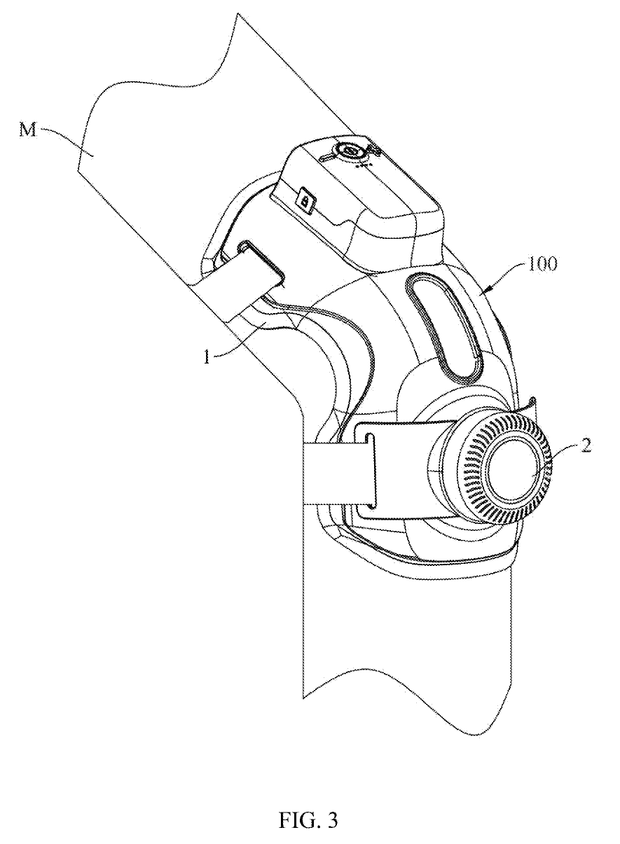

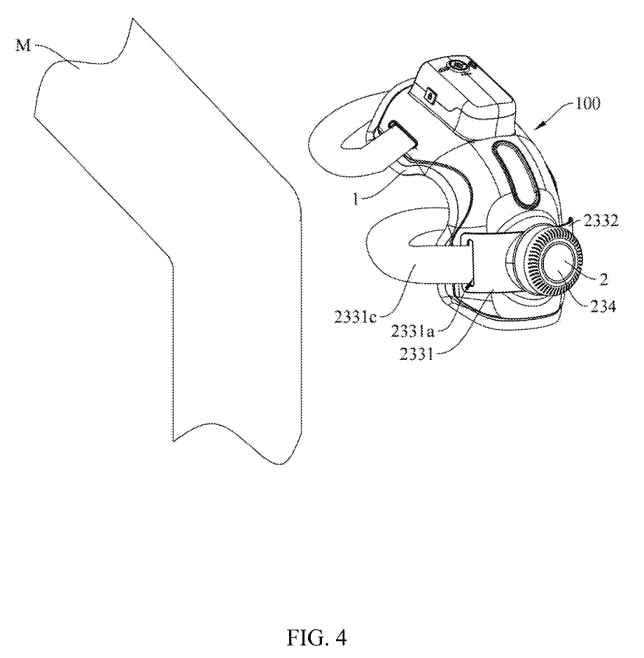

FIG. 1 is a schematic structural diagram of a massage device 100 according to some embodiments of the present disclosure, FIG. 2 is a schematic structural diagram of the massage device 100 in FIG. 1 from another angle, FIG. 3 is a schematic structural diagram of the massage device 100 in FIG. 1 when the massage device 100 is worn on a target area M, and FIG. 4 is a schematic structural diagram of the massage device 100 in FIG. 3 after the massage device 100 is detached from the target area M.

Referring to FIGS. 1 and 2, the massage device 100 includes a wearing mechanism 1 and a massage mechanism 2. Referring to FIGS. 3 and 4, the wearing mechanism 1 is used for being worn on the target area M. Referring to FIGS. 2 and 3, the wearing mechanism 1 includes a massage surface 10 adapted to the target area M, and the massage mechanism 2 corresponding to the massage surface 10 is arranged on the wearing mechanism 1.

It should be noted that the massage surface 10 refers to a surface of the wearing mechanism 1 that is in contact with the target area M when the wearing mechanism 1 is worn on the target area M. When the massage mechanism 2 of the massage device 100 starts a massage action, a force generated by the massage action can be transmitted to the target area M through the massage surface 10, so that the massage effect can be achieved.

In the case where the wearing mechanism 1 is made of a flexible material, when the wearing mechanism 1 is detached from the target area M, the massage surface 10 can be deformed along with the deformation of the wearing mechanism 1, but when the wearing mechanism 1 is worn on the target area M, a shape of the massage surface 10 is relatively fixed under the support of the target area M.

Taking the massage device 100 as a knee massager as an example, the target area M is a knee of a user, and the massage surface 10 is a surface of the wearing mechanism 1 that is fitted to a front surface of the knee.

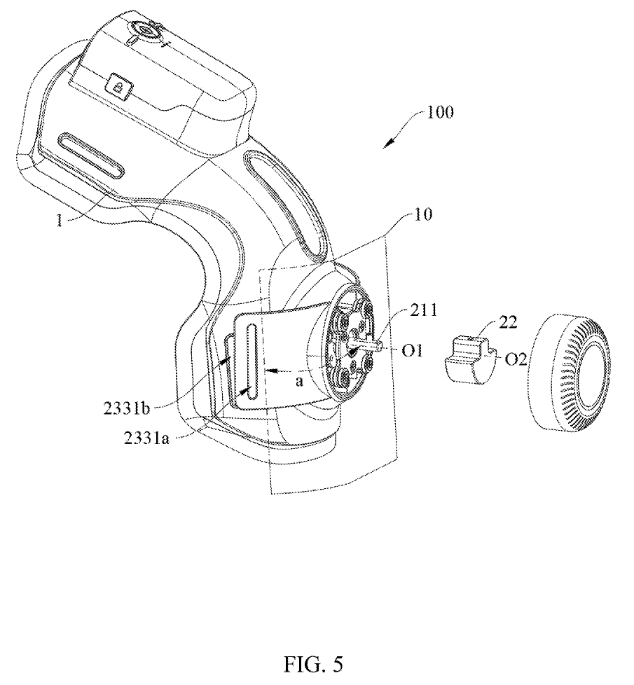

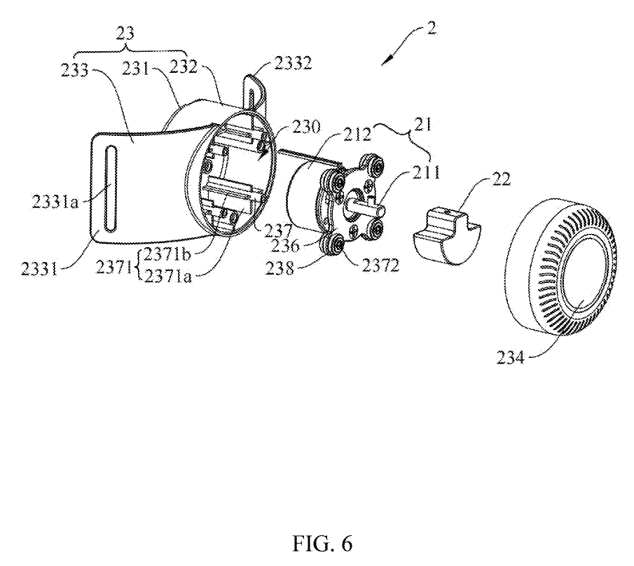

FIG. 5 is an exploded view of the massage device 100 in FIG. 1, and FIG. 6 is an exploded view of the massage mechanism 2 in FIG. 5. Referring to FIG. 5 and FIG. 6, the massage mechanism 2 includes a motor 21 and an eccentric structure 22, the eccentric structure 22 is arranged on a motor shaft 211 of the motor 21 and a gravity center of the eccentric structure 22 is offset from an axis O1 of the motor shaft 211, and a first included angle α is formed between the axis O1 of the motor shaft 211 and the massage surface 10.

When the massage surface 10 is a planar surface, the first included angle α is defined as a angle between the axis O1 and the planar surface. When the massage surface 10 is a non-planar surface (such as a curved surface, spherical surface, or other irregular surface), the first included angle α is defined as an angle between the axis O1 and a tangent plane of the massage surface at the intersection point with the axis O1. If multiple intersection points exist, the tangent plane at the intersection point on the axis O1 that is closet to the motor shaft 211 is used as the reference plane for determining the angle.

Due to the first included angle α between the axis O1 of the motor shaft 211 and the massage surface 10, when the motor shaft 211 rotates and drives the eccentric structure 22 to rotate along with the motor shaft 211, a flinging and rubbing massage action is formed on the massage surface 10 under the action of the eccentric structure 22. The flinging and rubbing massage action is often better than a pounding massage action in the related art in massage effect, and thus the massage effect can be improved to a certain extent.

In the related art, the massage mechanism 2 usually provides a pounding massage action to the target area M for massage, and the massage effect is usually improved by changing a pounding force. In the present disclosure, the inventor has found through repeated research that the flinging and rubbing massage action is more uniform in force on the target area M, and can reduce the risk of massage injury while achieving deep massage, and is often better than the pounding massage action in massage effect. Therefore, the present disclosure breaks the stereotype and provides a new way, and instead of improving the massage effect by changing the pounding force, the massage effect is improved by providing the flinging and rubbing massage action. The structure design is very ingenious, the massage effect is better, the massage device 100 is suitable for various types of massage and has a wider range of applications.

The massage device 100 can be a knee massager, a neck massager, a waist massager, an elbow massager, or the like, and the embodiments are not limited in this regard.

When the massage device 100 is a knee massager, the target area M can be a leg of a human body. Of course, the target area M can also be a leg of an animal, and the embodiments are not limited in this regard.

It should be noted that the eccentric structure 22 arranged on the motor shaft 211 of the motor 21 can be understood in a broad sense. In some embodiments, the eccentric structure 22 may be directly arranged on the motor shaft 211. Of course, in some embodiments, the eccentric structure 22 may be indirectly arranged on the motor shaft 211. For example, a disc may be arranged on the motor shaft 211, and the eccentric structure 22 may be arranged on the disc to achieve the purpose of being eccentrically arranged on the motor shaft 211. That is, the eccentric structure 22 only needs to be eccentric with respect to the motor shaft 211, and the specific arrangement manner is not limited in the embodiments.

In some embodiments, the massage device 100 may satisfy following relationship 70° ≤ α ≤ 110°.

The inventor has found through long-term research that when 70° ≤α≤ 110°, the flinging and rubbing massage action formed during the rotation of the eccentric structure 22 along with the motor shaft 211 is just right in force and other aspects, and thus the massage experience of the massage device 100 may be improved to a certain extent.

In some embodiments, the first included angle α may be 70°, 80°, 110°, or any other value that satisfies the relationship 70°≤α≤110°, and the embodiment is not limited in this respect.

In some embodiments, α= 90°.

The inventor has found that when α= 90°, the axis O1 of the motor shaft 211 can be perpendicular to the massage surface 10, and thus the kneading and shaking force at various positions of the massage surface 10 are relatively balanced when the eccentric structure 22 rotates with the motor shaft 211, thereby improving the massage effect of the massage device 100.

In some embodiments, referring to FIGS. 5 and 6, the motor 21 includes a motor shaft 211 and a motor body 212. The eccentric structure 22 is located on a side of the motor body 212 of the motor 21 away from the massage surface 10 (the right side of the motor body 212 in FIG. 6).

By locating the eccentric structure 22 on the side of the motor body 212 of the motor 21 away from the massage surface 10, the eccentric structure 22 may be located as far away from the massage surface 10 as possible, so that the eccentric structure 22 may form stronger kneading and shaking force when the eccentric structure 22 rotates with the motor shaft 211, thereby further improving the massage effect of the massage device 100.

In some embodiments, referring to FIG. 5 and FIG. 6, the massage mechanism 2 may further include a seat body 23, the seat body 23 is arranged on the wearing mechanism 1, and the motor 21 is arranged on the seat body 23.

On the one hand, by arranging the seat body 23, when the motor 21 needs to be mounted on the wearing mechanism 1, the motor 21 is only needed to be mounted on the seat body 23 first, and then the seat body 23 is mounted on the wearing mechanism 1, so that the motor 21 can be mounted on the wearing mechanism 1, which is very convenient.

On the other hand, by arranging the seat body 23, the seat body 23 can also act as a base for mounting the motor 21, so that the motor 21 can be mounted on the wearing mechanism 1 more stably without being directly connected to the wearing mechanism 1.

In some embodiments, referring to FIG. 5 and FIG. 6, the seat body 23 includes a base 231 and a surrounding wall 232. The base 231 is arranged on the wearing mechanism 1, the surrounding wall 232 is arranged on the base 231. The base 231 and the surrounding wall 232 enclose to form an installation cavity 230, and at least part of the motor 21 is accommodated in the installation cavity 230.

By accommodating at least part of the motor 21 in the installation cavity 230, on the one hand, the operation environment of the motor 21 may be safer, and on the other hand, the appearance of the massage device 100 may be more neat and beautiful.

In some embodiments, the seat body 23 may further include a binding assembly 233, the binding assembly 233 is connected to the surrounding wall 232, and is used for binding the surrounding wall 232 on the target area M.

By binding the surrounding wall 232 on the target area M through the binding assembly 233, on the one hand, the kneading and shaking action formed by the eccentric structure 22 can be transmitted to the target area M through the binding assembly 233, so that the target area M can better feel the kneading and shaking action, and the kneading and shaking massage effect of the massage device 100 is more prominent.

On the other hand, the binding assembly 233 can also play a role in binding the massage mechanism 2 on the target area M to a certain extent, so that the possibility of the whole massage device 100 falling from the target area M during the kneading and shaking process may be avoided or reduced to a certain extent.

It should be noted that, taking the massage device 100 as a knee massager as an example, the implementation manner of the binding assembly 233 for binding the surrounding wall 232 on the target area M has multiple. In a possible implementation manner, the binding assembly 233 may be a C-shaped binding ring, both ends of the C-shaped binding ring are fixed on the surrounding wall 232, and the C-shaped binding ring is sleeved on the leg, so that the purpose of binding the surrounding wall 232 on the target area M can be achieved.

In another possible implementation manner, referring to FIG. 3 and FIG. 6, the binding assembly 233 includes a first binding part 2331 and a second binding part 2332. One end of the first binding part 2331 is arranged on the surrounding wall 232, and the other end of the first binding part 2331 is connected to the wearing mechanism 1, the second binding part 2332 is arranged on a side of the surrounding wall 232 opposite to the first binding part 2331, one end of the second binding part 2332 is connected to the surrounding wall 232, and the other end of the second binding part 2332 is connected to the wearing mechanism 1.

Since one end of the first binding part 2331 is connected to the surrounding wall 232 and the other end of the first binding part 2331 is connected to the wearing mechanism 1, and one end of the second binding part 2332 is connected to the surrounding wall 232 and the other end of the second binding part 2332 is connected to the wearing mechanism 1, the surrounding wall 232 can be bound on the wearing mechanism 1, and then, when the wearing mechanism 1 is worn on the target area M, the purpose of binding the surrounding wall 232 on the target area M through the first binding part 2331 and the second binding part 2332 can be indirectly achieved.

In addition, by connecting the first binding part 2331 and the second binding part 2332 to opposite sides of the surrounding wall 232, the opposite sides of the surrounding wall 232 are subjected to a force from the first binding part 2331 and a force from the second binding part 2332, respectively, so that the surrounding wall 232 can be stably and reliably bound on the wearing mechanism 1.

It should be noted that the implementation manner of the other end of the first binding part 2331 being connected to the wearing mechanism 1 has multiple. In a possible implementation manner, referring to FIG. 4 and FIG. 5, the other end of the first binding part 2331 may be provided with a first binding hole 2331a, and the wearing mechanism 1 may be provided with a second binding hole 2331b, and the purpose of connecting the other end of the first binding part 2331 to the wearing mechanism 1 can be achieved by threading a binding belt 2331c through the first binding hole 2331a and the second binding hole 2331b.

In some embodiments, referring to FIG. 4 and FIG. 6, the massage mechanism 2 may further include a cover 234, which is detachably arranged on the surrounding wall 232 to cover the motor 21 and the eccentric structure 22 in the installation cavity 230.

By arranging the cover 234, the motor 21 and the eccentric structure 22 can be covered, so that on the one hand, the whole massage device 100 is more beautiful, and on the other hand, the operation environment of the entire motor 21 and eccentric structure 22 is safer, and the user can be prevented from being scratched during the operation of the motor 21 or the operation of the eccentric structure 22.

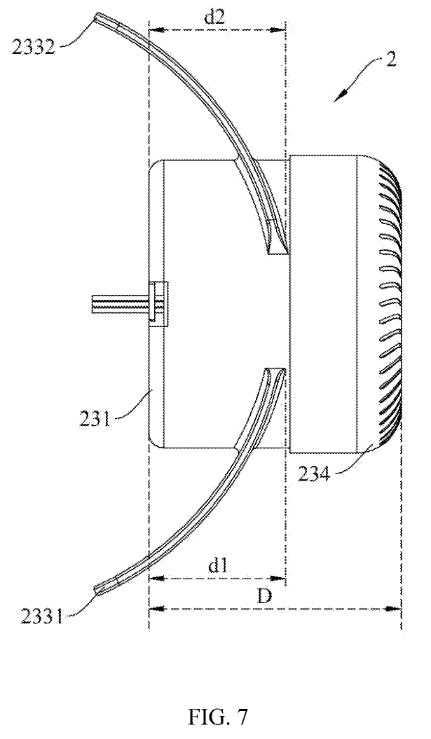

In some embodiments, referring to FIG. 7, which is a structural schematic diagram of the massage mechanism in FIG. 6 after disassembly, the maximum distance between the base 231 and the cover 234 is D. The maximum distance between the end of the first binding part 2331 connected to the surrounding wall 232 and the base 231 is d1, the maximum distance between the end of the second binding part 2332 connected to the surrounding wall 232 and the base 231 is d2, and the massage device 100 may satisfy at least one of following relationships (1/4)D≤d1≤(3/4)D, and (1/4)D≤d2≤(3/4)D.

By satisfying at least one of the relationships (1/4)D≤d1≤(3/4)D and (1/4)D≤d2≤(3/4)D, on the one hand, the binding effect of the second binding part 2332 and the first binding part 2331 on the surrounding wall 232 is stronger, and on the other hand, the second binding part 2332 and the first binding part 2331 can better transmit the kneading and shaking action to the target area M.

In some embodiments, d1 may be (1/4)D, (2/4)D, (3/4)D, or any other value that satisfies the relationship (1/4)D≤d1≤(3/4)D, and the embodiment is not limited in this regard.

In some embodiments, d2 may be (1/4)D, (2/4)D, (3/4)D, or any other value that satisfies the relationship (1/4)D≤d2≤(3/4)D, and the embodiment is not limited in this regard.

In some embodiments, d1=(1/2)D and/or d2=(1/2)D.

The inventors have found that when the massage device 100 satisfies at least one of the relationships d1=(1/2)D and d2=(1/2)D, the binding effect of the second binding part 2332 and the first binding part 2331 on the surrounding wall 232 may be further strengthened, and at the same time, the kneading and shaking action may be better transmitted to the target area M.

In some embodiments, referring to FIG. 6, the massage mechanism 2 may further include a installation part 236, a plurality of installation columns 237 are arranged on the seat body 23, the plurality of installation columns 237 are located in the installation cavity 230, the installation part 236 is arranged on the installation columns 237 and spaced apart from the base 231, and the motor 21 is arranged on the installation part 236 and spaced apart from the base 231.

By arranging the motor 21 on the installation part 236 and spaced apart from the base 231, the motor 21 is not in contact with the base 231, in other words, the motor 21 is suspended relative to the base 231, so that the possibility of the vibration and noise transmitted outward through the base 231 during the operation of the motor 21 may be reduced to a certain extent, which allows the operation of the massage device 100 to be quieter.

In some embodiments, referring to FIG. 6, the motor body 212 of the motor 21 is mounted on the installation part 236 and located between the installation part 236 and the base 231, the motor shaft 211 of the motor 21 extends to a side of the installation part 236 away from the base 231, and the eccentric structure 22 is located on the side of the installation part 236 away from the base 231.

By locating the motor body 212 of the motor 21 between the installation part 236 and the base 231 and locating the eccentric structure 22 on the side of the installation part 236 away from the base 231, the motor body 212 and the eccentric structure 22 are respectively located on opposite sides of the installation part 236, so that on the one hand, the motor body 212 and the eccentric structure 22 can fully utilize space on both sides of the installation part 236, so that the massage mechanism 2 has a more reasonable structural layout and a smaller size. On the other hand, the eccentric structure 22 can be prevented from interfering with the motor body 212 during rotation.

Further, in order to better prevent the vibration and noise of the motor 21 from being transmitted outward during the operation of the motor 21, in some embodiments, referring to FIG. 6, the installation part 236 is floatingly connected to the installation column 237.

By floatingly connecting the installation part 236 to the installation column 237, the vibration of the motor 21 can be transmitted to the installation part 236 but cannot be transmitted or is less transmitted to the installation column 237 during the operation of the motor 21, so that the vibration and noise of the motor 21 can be better prevented from being transmitted outward during the operation of the motor 21.

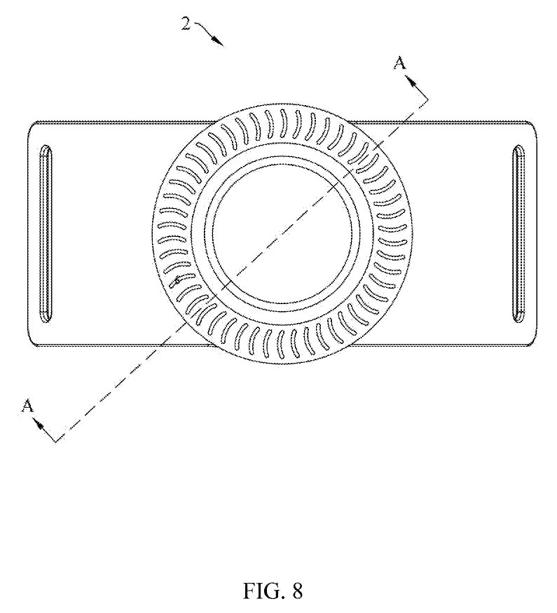

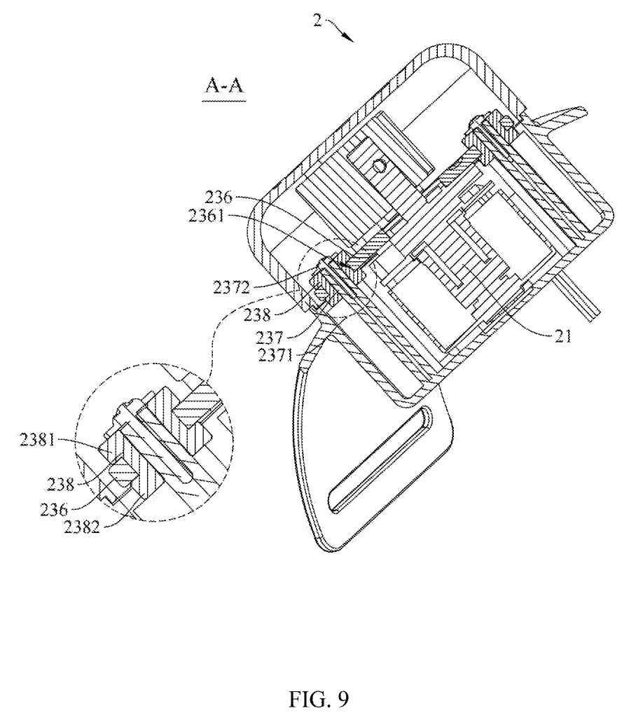

In some embodiments, referring to FIGS. 6, 8 and 9, FIG. 8 is a structural schematic diagram of the massage mechanism in FIG. 7 from another perspective, and FIG. 9 is a sectional view of the massage mechanism 2 in FIG. 8 at a position A-A, a flexible part 238 is sleeved on the installation column 237, the installation part 236 is provided with a installation hole 2361, and the installation part 236 is sleeved on the flexible part 238 through the installation hole 2361.

Since the flexible part 238 is sleeved on the installation column 237 and the installation part 236 is sleeved on the flexible part 238 through the installation hole 2361, the flexible part 238 is arranged between the installation part 236 and the installation column 237, so that when the vibration of the motor 21 is transmitted to the installation part 236 during the operation of the motor 21, the flexible part 238 can absorb all or part of the vibration of the motor 21, so that the vibration of the motor 21 cannot be transmitted to the installation column 237, and the vibration and noise of the motor 21 can be prevented from being transmitted outward through the installation column 237 during the operation of the motor 21.

In order to enhance the strength of the installation column 237, in some embodiments, referring to FIG. 6, a reinforcing rib 2371 is arranged on the installation column 237 and extends along an axial direction of the installation column 237.

By arranging the reinforcing rib 2371 on the installation column 237, the reinforcing rib 2371 can enhance the mechanical strength of the installation column 237, so that the installation column 237 is more durable.

In some embodiments, referring to FIG. 6, multiple reinforcing ribs 2371are arranged on the installation column 237, the multiple reinforcing ribs 2371 includes a first reinforcing rib 2371a and a second reinforcing rib 2371b. The first reinforcing rib 2371a extends from the installation column 237 to be connected with the surrounding wall 232, and an end of the second reinforcing rib 2371b away from the installation column 237 is a free end.

Since the first reinforcing rib 2371a is connected the surrounding wall 232 and the installation column 237, the surrounding wall 232 can enhance the strength of the first reinforcing rib 2371a, thereby indirectly enhancing the mechanical strength of the installation column 237.

In addition, since the end of the second reinforcing rib 2371b away from the installation column 237 is a free end, the second reinforcing rib 2371b can be arranged flexibly in position without being deliberately arranged close to the surrounding wall 232.

In some embodiments, referring to FIG. 6 and FIG. 9, a locking part 2372 is arranged on the installation column 237, and the flexible part 238 is limited between the locking part 2372 and the reinforcing rib 2371 in the axial direction of the installation column 237.

By limiting the flexible part 238 between the locking part 2372 and the reinforcing rib 2371 in the axial direction of the installation column 237, the flexible part 238 can be stably fixed by the locking part 2372 and the reinforcing rib 2371, thereby preventing the flexible part 238 from falling off.

The locking part 2372 may be a screw or any other part capable of limiting the flexible part 238 between the locking part 2372 and the reinforcing rib 2371 in the axial direction of the installation column 237, and a structure of the locking part 2372 is not limited in the embodiment.

In some embodiments, referring to FIG. 9, a first protruding ring 2381 and a second protruding ring 2382 are arranged on a peripheral wall of the flexible part 238, and the first protruding ring 2381 and the second protruding ring 2382 are located on opposite sides of the installation part 236 in the axial direction of the installation column 237 and respectively abut against the installation part 236.

Since the first protruding ring 2381 and the second protruding ring 2382 are arranged on opposite sides of the installation part 236 in the axial direction of the installation column 237 and respectively abut against the installation part 236, the installation part 236 can be wrapped by the first protruding ring 2381, the second protruding ring 2382, and the peripheral wall of the flexible part 238, thereby better preventing the vibration on the installation part 236 from being transmitted to the installation column 237.

In some embodiments, referring to FIG. 9, the first protruding ring 2381, the second protruding ring 2382 and the flexible part 238 are integrally formed, and the first protruding ring 2381 and the second protruding ring 2382 are both flexible protruding rings.

Since the first protruding ring 2381 and the second protruding ring 2382 are both flexible protruding rings, the vibration of the installation part 236 can be better prevented from being transmitted to the installation column 237.

In addition, by integrally forming the first protruding ring 2381, the second protruding ring 2382 and the flexible part 238, the number of parts of the massage device 100 can be reduced to a certain extent, and the assembly complexity of the massage device 100 can be reduced.

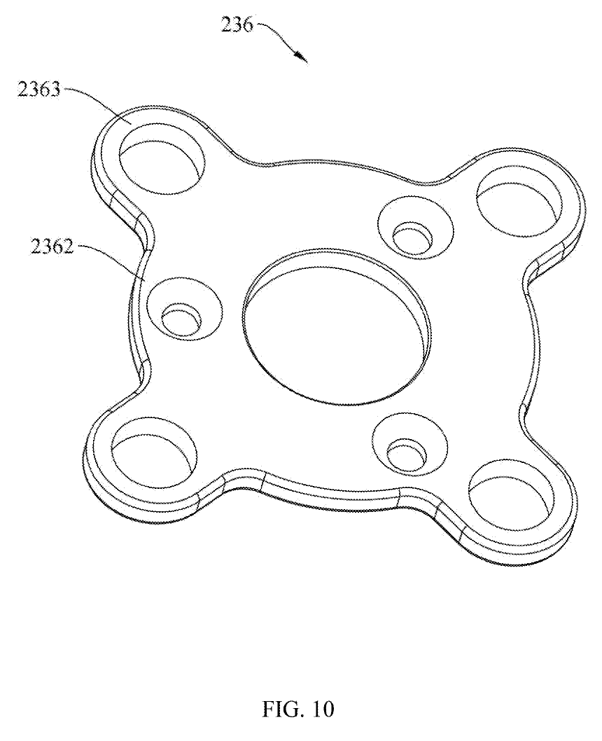

In some embodiments, referring to FIG. 6 and FIG. 10, the installation part 236 may include a installation body 2362 and a plurality of lugs 2363, the motor 21 is arranged on the installation body 2362, the plurality of lugs 2363 are arranged on the installation body 2362 and each of the plurality of lugs 2363 corresponds to and is connected to a respective one of the plurality of installation columns 237.

In this way, the installation body 2362 can be designed to be relatively small under the premise that the installation part 236 can be connected to the plurality of installation columns 237, so that the structure of the whole installation part 236 is more compact, and there is no redundant waste material.

In some embodiments, the number of the plurality of lugs 2363 may be four as shown in FIG. 10, and of course, the number of the plurality of lugs 2363 may be other possible numbers, which is not limited in the embodiment.

In some embodiments, referring to FIG. 1 and FIG. 2, the wearing mechanism 1 includes a first section 111, a bending section 112 and a second section 113, the first section 111, the bending section 112 and the second section 113 are sequentially connected, and a second included angle is formed between the second section 113 and the first section 111. The second section 113 forms the massage surface 10, or the bending section 112 forms the massage surface 10.

By forming the second included angle between the second section 113 and the first section 111, the wearing mechanism 1 is a curved structure, and when the wearing mechanism 1 is a curved structure, the wearing mechanism 1 can be better adapted to the joint parts, such as the knee joint and the elbow joint.

When the second section 113 forms the massage surface 10, the massage surface 10 can be staggered with a joint portion of the joint part, so as to facilitate the bending or stretching of the joint part.

When the bending section 112 forms the massage surface 10, the massage surface 10 can correspond to the joint portion of the joint part, and the massage effect is better.

In some embodiments, referring to FIG. 1, the second section 113 forms the massage surface 10, and a through hole 1121 penetrates the bending section 112 along a thickness direction of the bending section.

Since the through hole 1121 penetrates the bending section 112 along the thickness direction of the bending section 112, the wearing mechanism 1 has higher air permeability, and the situation that the target area M is suffocated is avoided.

In some embodiments, as shown in FIG. 1, the through hole 1121 may be a strip-shaped hole extending along an arrangement direction of the first section 111, the bending section 112 and the second section 113.

The through hole 1121 is a strip-shaped hole extending along the arrangement direction of the first section 111, the bending section 112 and the second section 113, so that a length of the strip-shaped hole is as long as possible, and the wearing mechanism 1 has higher air permeability.

In some embodiments, as shown in FIG. 2, the wearing mechanism 1 may include a first housing 11 and a second housing 12, the massage mechanism 2 is arranged on the first housing 11, the second housing 12 is arranged on a side of the first housing 11 in a laminated manner along a thickness direction of the first housing 11, a hardness of the second housing 12 is less than that of the first housing 11, and the massage surface 10 is formed on the second housing 12.

The hardness of the second housing 12 is less than that of the first housing 11, and the massage surface 10 is formed on the second housing 12, so that when the massage device 100 is worn on the human body, the human body feels softer and more comfortable.

A material of the second housing 12 may be cloth, and a material of the first housing 11 may be silica gel. In some embodiments, the second housing 12 and the first housing 11 may be other possible materials, and the embodiments are not limited in this respect.

In some embodiments, as shown in FIG. 5, the eccentric structure 22 includes a semicircular disc part 221 arranged on the motor shaft 211.

The semicircular disc part 221 is an eccentric structure, so when the eccentric structure 22 includes the semicircular disc part 221, the eccentric structure 22 can form a swinging motion when rotating along with the motor shaft 211, thereby producing a kneading and shaking massage effect.

The semicircular disc part 221 has a simple structure, so the cost of the eccentric structure 22 can be reduced.

In some embodiments, as shown in FIG. 5, the axis O1 of the motor shaft 211 coincides with an axis O2 of a circumcircle of the semicircular disc part 221.

The axis O1 of the motor shaft 211 coincides with the axis O2 of the circumcircle of the semicircular disc part 221, so that the centrifugal force acting on the semicircular disc part 221 when rotating along with the motor shaft 211 is relatively balanced, thereby ensuring the stability of the rotation of the semicircular disc part 221.

In some embodiments, as shown in FIG. 6, a thickness of the semicircular disc part 221 along the axis O2 of the circumcircle may be in a range of 10mm to 14mm, and/or a diameter of the circumcircle of the semicircular disc part 221 may be in a range of 32mm to 40mm.

The inventor has found that when the thickness of the semicircular disc part 221 along the axis O2 of the circumcircle is less than 10mm, the kneading and shaking effect brought about by the rotation of the semicircular disc part 221 along with the motor shaft 211 is not obvious, and when the thickness of the semicircular disc part 221 along the axis O2 of the circumcircle is greater than 14mm, the semicircular disc part 221 becomes excessively thick and heavy, so that the power requirement of the motor 21 is higher. Therefore, when the thickness of the semicircular disc part 221 along the axis O2 of the circumcircle is within the range of 10mm to 14mm, the kneading and shaking effect brought about by the rotation of the semicircular disc part 221 along with the motor shaft 211 is better, and the power requirement of the motor 21 is more reasonable.

The inventor has also found that when the diameter of the circumcircle of the semicircular disc part 221 is less than 32mm, the kneading and shaking effect brought about by the rotation of the semicircular disc part 221 along with the motor shaft 211 is not obvious, and when the diameter of the circumcircle of the semicircular disc part 221 is greater than 40mm, a size of the semicircular disc part 221 is too large, and the power requirement of the motor 21 is also higher. Therefore, when the diameter of the circumcircle of the semicircular disc part 221 is within the range of 32mm-40mm, the kneading and shaking effect brought about by the rotation of the semicircular disc part 221 along with the motor shaft 211 is better, and the power requirement of the motor 21 is also more reasonable.

Finally, it should be noted that the above examples are only used to illustrate the technical solutions of the present disclosure, and are not intended to limit the present disclosure. Although the present disclosure has been described in detail with reference to the foregoing embodiments, those skilled in the art should understand that they can still make modifications to the technical solutions described in the foregoing embodiments, or make equivalent replacements to some or all of the technical features; and these modifications or replacements do not cause the essence of the corresponding technical solutions to deviate from the scope of the technical solutions of the embodiments of the present disclosure.

What is claimed is:

1. A massage device, comprising:
a wearing mechanism configured to be worn on a target area, the wearing mechanism comprising a massage surface matched with the target area; and
a massage mechanism disposed on the wearing mechanism and corresponding to the massage surface, the massage mechanism comprising a motor and an eccentric structure, wherein the motor comprises a motor shaft, the eccentric structure is disposed on the motor shaft of the motor and has a gravity center deviated from an axis of the motor shaft, and a first included angle is formed between the axis of the motor shaft and the massage surface and defined as α.

2. The massage device of claim 1, wherein 70° ≤ α≤ 110°.

3. The massage device of claim 1, wherein the motor further comprises a motor body, the eccentric structure is located on a side of the motor body of the motor facing away from the massage surface.

4. The massage device of claim 1, wherein the massage mechanism further comprises a seat body disposed on the wearing mechanism, and the motor is disposed on the seat body.

5. The massage device of claim 4, wherein the seat body comprises a base disposed on the wearing mechanism and a surrounding wall disposed on the base, an installation cavity is enclosed by the base and the surrounding wall, and at least part of the motor is accommodated in the installation cavity.

6. The massage device of claim 5, wherein the seat body further comprises:
a binding assembly connected to the surrounding wall and configured to bind the surrounding wall to the target area.

7. The massage device of claim 6, wherein the binding assembly comprises a first binding part and a second binding part,
an end of the first binding part is arranged on the surrounding wall and another end of the first binding part is connected to the wearing mechanism;
an end of the second binding part is arranged on the surrounding wall and another end of the second binding part is connected to the wearing mechanism, the second binding part and the first binding part are located opposite sides of the surrounding wall, respectively.

8. The massage device of claim 7, wherein the massage mechanism further comprises:
a cover detachably covering the surrounding wall to cover the motor and the eccentric structure that are located in the installation cavity.

9. The massage device of claim 8, wherein a maximum distance between the base and the cover is defined as D,
a maximum distance between an end of the first binding part connected to the surrounding wall and the base is defined as d1,
a maximum distance between an end of the second binding part connected to the surrounding wall and the base is defined as d2,
the massage device satisfies at least one of following relationships (1/4)D≤d1≤(3/4)D, and (1/4)D≤d2≤(3/4)D.

10. The massage device of claim 6, wherein the massage mechanism further comprises a installation part, a plurality of installation columns are disposed on the seat body, the plurality of installation columns are located in the installation cavity, the installation part corresponding to the base is disposed on the plurality of installation columns and spaced apart from the base, the motor corresponding to the base is disposed on the installation part and spaced apart from the base.

11. The massage device of claim 10, wherein the motor further comprises a motor body, the motor body of the motor is mounted on the installation part and located between the installation part and the base, the motor shaft of the motor extends to a side of the installation part facing away from the base, and the eccentric structure is located at the side of the installation part facing away from the base.

12. The massage device of claim 10, wherein the installation part is floatingly connected to the plurality of installation columns.

13. The massage device of claim 12, wherein a flexible part is sleeved on a installation column of the plurality of installation columns, and the installation part is provided with a installation hole and is sleeved on the flexible part through the installation hole.

14. The massage device of claim 13, wherein the installation column is provided with a reinforcing rib extending along an axial direction of the installation column.

15. The massage device of claim 14, wherein the installation column is provided with a plurality of reinforcing ribs comprises the reinforcing rib, the plurality of reinforcing ribs comprises a first reinforcing rib and a second reinforcing rib, the first reinforcing rib extends from the installation column to be connected to the surrounding wall, and an end of the second reinforcing rib away from the installation column is a free end.

16. The massage device of claim 14, wherein the installation column is provided with a locking part, and the flexible part is limited between the locking part and the reinforcing rib along the axial direction of the installation column.

17. The massage device of claim 1, wherein the wearing mechanism comprises a first section, a bending section, and a second section,
the first section, the bending section and the second section are connected in sequence, and a second included angle is formed between the second section and the first section;
the second section forms the massage surface, or the bending section forms the massage surface.

18. The massage device of claim 17, wherein the second section forms the massage surface, and a through hole penetrates the bending section along a thickness direction of the bending section.

19. The massage device of claim 18, wherein the through hole is a strip-shaped hole extending along an arrangement direction of the first section, the bending section and the second section.

20. The massage device of claim 1, wherein the wearing mechanism comprises a first housing and a second housing,
the massage mechanism is disposed on the first housing;
the second housing is disposed on a side of the first housing in a thickness direction of the first housing, a hardness of the second housing is less than a hardness of the first housing, and the massage surface is formed on the second housing.
